(19) United States
(12) Patent Application Publication
(10) Pub. No.: US 2024/0430233 A1
(43) Pub. Date: Dec. 26, 2024

(54) Data Firewall for Enterprise Use of LLM Systems

(71) Applicant: PLURILOCK SECURITY SOLUTIONS INC., Victoria (CA)

(72) Inventors: Jord TANNER, Sooke (CA); Youssef NAKKABI, Victoria (CA); Ian PATERSON, Victoria (CA)

(21) Appl. No.: 18/750,302

(22) Filed: Jun. 21, 2024

Related U.S. Application Data
(60) Provisional application No. 63/522,254, filed on Jun. 21, 2023.

(51) Int. Cl. H04L 9/40; G06F 21/62

(52) U.S. Cl. CPC H04L 63/0245; G06F 21/6245

(57) ABSTRACT

Various implementations disclosed herein include devices, systems, and methods that detect interaction with Large Language Model (LLM) Artificial Intelligence (AI) services and limit data provided to such services.

### RELATED APPLICATIONS

This application claims the benefit of U.S. Provisional Application Ser. No. 63/522,254 filed Jun. 21, 2023 and entitled “DATA FIREWALL FOR ENTERPRISE USE OF LLM SYSTEM,” which is incorporated herein in its entirety.

### TECHNICAL FIELD

The present disclosure generally relates to monitoring usage of electronic devices for potentially harmful activities and, in particular to, systems, devices and methods for monitoring for and controlling the use of artificial intelligence systems.

### BACKGROUND

People use artificial intelligence (AI) applications, including those associated with Large Language Model (LLM) AI service providers, in various ways. In many use cases, people provide input requests, e.g., text, voice, etc., to such LLM service providers and receive responses based on the information in those input requests. Providing sensitive and/or private information in such input requests may publicly release or otherwise expose such information within those requests to the LLM service providers themselves, other users of those service providers, etc.

### SUMMARY

Various implementations disclosed herein include devices, systems, and methods that detect an interaction with an AI provider and limits data provided to that AI provider.

Some implementations involve a method performed by a processor executing instructions stored in a non-transitory computer-readable medium. The method may be performed by a device such as a firewall component or server. The method involves monitoring usage of an electronic device to detect an interaction initiated with a LLM AI application associated with an LLM AI service provider. For example, this may involve detecting that a device is being used to execute an application such as a web browser to access a service such as ChatGPT. This may involve monitoring application usage and/or messages/communications initiated from a particular device, such as a device managed by a business entity. The monitoring may be performed by firewall that monitors incoming and outgoing network traffic. The monitoring may be performed by a component positioned in a network architecture between one or more enterprise user devices and external cloud-based applications.

The method may involve, in response to detecting the interaction, determining a limitation on the information permitted to be provided to the LLM AI service provider. For example, one or more limitations may be determined based on accessing a usage policy or data privacy policy that specifies allowed and prohibited information that may be provided in a particular context, to particular services, and/or from particular devices.

The method may involve identifying information submitted in a user interface as input to the LLM AI application to prompt a response generated by the LLM AI service provider. The method may involve enabling provision of a first subset of less than all of the information to the LLM AI service provider as the input. A second subset, different than the first subset, of the information may be withheld from being provided to the LLM AI service provider in accordance with the limitation. Enabling provision of the first subset of less than all of the information may involve filtering the information to remove the second subset of information based on the second subset of information satisfying a criterion. Enabling provision of the first subset of less than all of the information comprising a data loss prevention engine (DLP) identifying sensitive data. Sensitive data may be data that is identified as including personal identifiable information (PII), protected health information (PHI), credit card numbers, enterprise secrets, source code, passwords, passkeys, financial data, merger and acquisition data, and/or data not approved for use outside of an enterprise.

Some implementations additionally or alternatively involve automatically generalizing the first subset of information to remove sensitive information, for example, by removing names, values, substituting general wording for specific wording, etc.

Some implementations additionally involve identifying information received from the LLM AI service provider and associating the received information with the input. Some implementations involve watermarking the information received to associate the information received with a user who provided the input. Some implementations involve logging the first subset of less than all of the information as having been provided to the LLM AI service provider. Some implementations involve initiating a right to be forgotten request to the LLM AI service provider based on determining that the first subset of less than all of the information was provided as input and contains data that satisfies a criterion.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 illustrates a monitoring device monitoring interactions in accordance with some implementations.

FIG. 2 illustrates an exemplary monitoring and control process, in accordance with some implementations.

FIG. 3 is a flowchart illustrating an exemplary method for enabling provision of limited information to LLM AI providers in accordance with some implementations.

FIG. 4 is a block diagram of a device of in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations. Those of ordinary skill in the art will appreciate that other effective aspects or variants do not include all of the specific details described herein. Moreover, well-known systems, methods, components, devices and circuits have not been described in exhaustive detail so as not to obscure more pertinent aspects of the example implementations described herein.

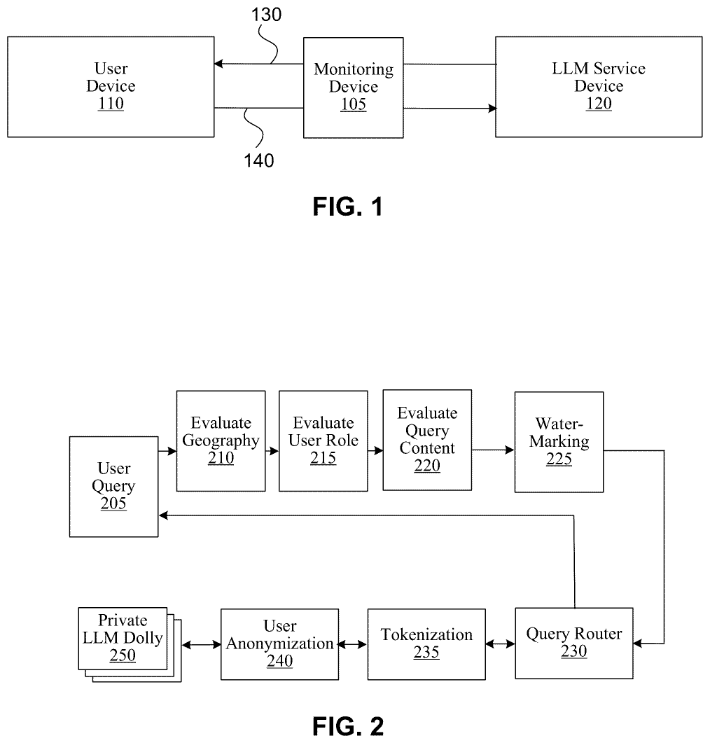

FIG. 1 illustrates an exemplary monitoring device 105 monitoring interactions 130, 140 between user device 110 and LLM service device 120. In this example, the LLM service device 120 is configured to receive communications that provide requests providing input that is processed by one or more artificial intelligence models, e.g., neural networks, large language models, etc. The LLM service device 120 is configured to provide the output of such models back to the requesters. The requests and responses may be transmitted via one or more communication networks. In this example, the user device 110 is operated by a user who initiates an interaction with the LLM service. For example, the user device 110 may execute a web browser or application that provides a user interface associated with the LLM service, e.g., a UI configured to receive text, voice, or other input that is provided in input requests sent as communications to the LLM service device 120. In some implementations, the user device 105 initiates an interaction with the LLM service device 120 by accessing its webpage, opening its application, sending a connection requests, sending an input request, or otherwise communicating an intention to interact. In this example, the monitoring device 105 is configured to detect when user device initiates an interaction with the LLM service device 120. The user device 110 itself may perform or be involved in such monitoring. For example, the user device 110 may include programs, agents, or other software configured to collect and send data regarding device usage to the monitoring device 105.

In some implementations, the monitoring device 105 implements one or more Cloud Access Security Broker (CASB) technologies to provide features that are positioned between enterprise users and external cloud apps (e.g., Salesforce.com®, Slack®, personal email access, etc.). CASB features may be configured to prevent enterprise users from doing things against an enterprise's policy. For example, a feature may be positioned between a user and a personal e-mail system and prevent the user from dragging an enterprise file into the personal e-mail system or sending a customer file to the personal e-mail address. The CASB features may be configured to be a checkpoint between the enterprise user and cloud apps that enable enterprise controls.

Some implementations utilize a checkpoint/firewall/CASB-like feature positioned in between users and one or more artificial intelligence (AI) models, such as a generative pre-trained (GPT) AI models and/or large language model (LLM) AI models including, but not limited to, ChatGPT®, GPT-4®, GitHub Copilot®, OpenAI Playground®, Bing AI®, Amazon Codewhisperer®, ChatSonic®, Tabnine®, Amazon Alexa®, Apple Siri®, Google Assistant®, etc.

Some implementations enable a user to still interact with an AI with some limitations and/or filtering. Rather than providing confidential and/or sensitive information to the AI, a filter may be applied to ensure that inappropriate information is not provided to the AI. For example, a physician may be enabled to interact with a GPT system but would be prevented from sending a confidential patient record (or confidential details thereof) to the GPT system. Or, the filter may strip out personally identifiable information (PII) or other forms of sensitive data (personal health information, etc.) and send the sanitized data to the AI system. In some implementations, private, enterprise, personal, or other information that is not for external use is identified and prevented from being included in information provided to the GPT system or other AI system. In some implementations, such information is identified and generalized, modified, or obscured to remove information that is not for external use.

Some implementations apply existing data loss prevention (DLP) engines or other technologies to identify “Sensitive Data” (personal identifiable information (PII), protected health information (PHI), credit card numbers, enterprise secrets, source code, passwords or passkeys, financial data, M&A data and/or other data that is not for external use).

Some implementations apply security control extended to AI models.

FIG. 2 illustrates an exemplary monitoring and control process. In this example, a user query is entered at block 205. The process evaluates the geography associated with the query at block 210, evaluates the user role at block 215, evaluates the query content at block 210, and performs watermarking (e.g., for tracking purposes) at block 225. The query may be modified, filtered, or limited based these evaluations. The query is routed at the query router block 290. Tokenization is performed at block 235 and user anonymization is performed at block 240. A private LLM dolly is provided in block 250. Communications (e.g., with responses from the LLM) are received and provided back to the user device.

Some implementations provide one or more of the following features.
1. A user within a corporation may have access to several different LLM services. These LLM services may exist in different geographies and may be private to the corporation.
2. The user can access private data, such as technical trade secrets, PII, PHI, etc.
3. The user enters LLM queries into a system with one or more of the following components:
   a. An interactive query interface, or an API query interface for embedding into other systems
   b. An API layer to connect the interface to the router
   c. A context and content aware query router
      i. Aware of the user's computing device, user name, user role, locations, and other attributes
      ii. Connection into and making use of a corporate policy engine, to further specify and govern the use of data
      iii. Detects and tags private or personal identifying information or Sensitive Data, or data matching custom criteria
      iv. Routes the LLM query to an LLM service that complies with the privacy policies and statutes.
      v. The router could also send the query to an LLM service that can best answer the query (i.e., domain specific LLM services)
      vi. If tagged data elements exist, the elements are passed through a redaction/de-redaction or tokenization engine
      vii. For example, queries from a user in the European Union (EU) containing PII may be routed to a private LLM engine hosted in the EU.
      viii. The routing may use encryption for data in transit and data at rest, with varying levels of encryption depending on the need (such as quantum-resistant encryption for certain data, encryption complying with relevant jurisdictional needs for levels of encryption, etc.)
      ix. Identifying information about the requesting user is stripped/obfuscated and anonymized. This prevents any direct correlation between the user identity and the query to the end LLM.
   d. A redaction/de-redaction engine
      i. Redaction—scans for tagged data elements, replaces with unique tokens.
      ii. De-redaction—Scans for unique tokens, replaces with the original data element
4. The user query is routed and redacted
5. The query response is routed in reverse and de-redacted
6. The user can safely send LLM queries containing sensitive data and use the subsequent response without taking extra steps.

Various additional factors may be accounted for and features implemented.

Some implementations use a watermarking step as a post-process on the returning data to associate the user with the specific request.

Some implementations include logging and archiving considerations to meet organizational and/or regulatory obligations.

Some implementations will include meta data required for various privacy regulations such as California CCPA, Europe's GDPR, Canada's PIPEDA and similar, logging and archiving to ensure that ‘explainability’ of the data and data processing can be used to answer questions including: (a) how was data collected; (b) how is it processed.

Some implementations include logging and recording keeping to enable organizational tracking of data processing, to allow ‘right to be forgotten’ data requests to be sent to downstream LLM processors.

Some implementations fine-tune a model for Cybersecurity Incident Classification using SIEM Data (data from Microsoft® Sentinel®, Splunk®, etc.).

Some implementations perform code analysis using LLM to avoid code leaks. Some implementations provide privacy-preserving prompt tuning for LLM (privatizing data).

Some implementations utilize a federated learning approach. Fine-tuning a local model to preserve privacy and aggregate models to build a large model (e-mail attribution and authorship).

Some implementations provide phishing detection using LLMs by fine-tuning a model using phishing emails.

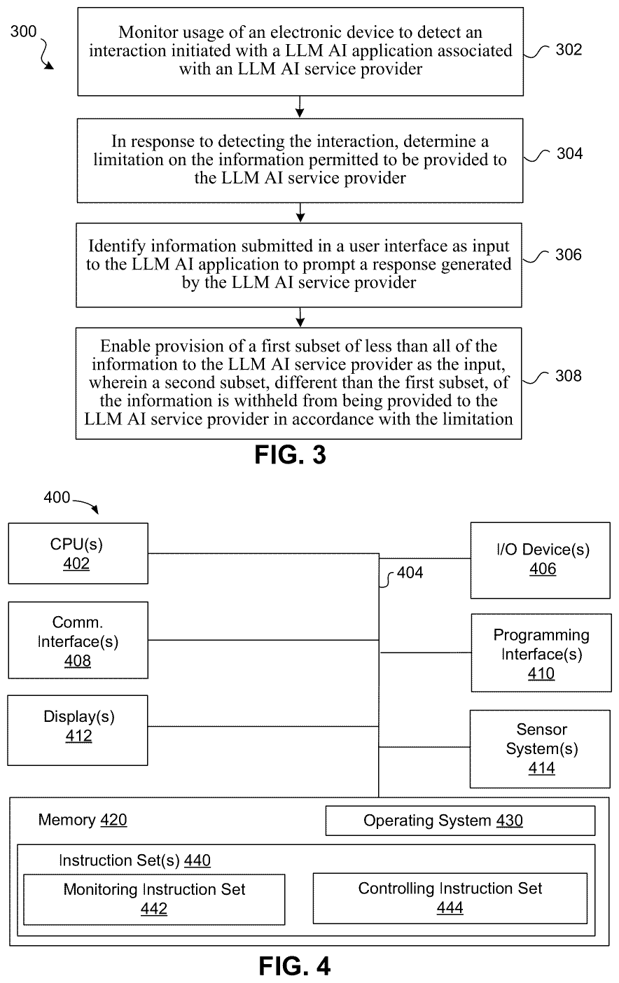

FIG. 3 is a flowchart illustrating a method 400 for enabling provision of limited information to LLM AI providers. In some implementations, a device such as electronic device 105, user device 110, or a combination of devices performs the steps of the method 300. In some implementations, method 300 is performed on a desktop, laptop, or server device. The method 300 is performed by processing logic, including hardware, firmware, software, or a combination thereof. In some implementations, the method 300 is performed on a processor executing code stored in a non-transitory computer-readable medium (e.g., a memory).

At block 302, the method 300 involves monitoring usage of an electronic device to detect an interaction initiated with a LLM AI application associated with an LLM AI service provider. This function may be performed at an application level and/or a network level. In some implementations, at the endpoint level, a monitoring software tracks an application's activity on the device. Ot may log predefined specific type of activity such as when a browser or local LLM application is accessed. In some implementations, at the network level, a monitoring solution is used to detect traffic between one or more user devices and one or more remote LLM AI servers. This may involve inspecting the HTTPS traffic for specific domains or IP addresses associated with one or more service providers.

Block 302 may involve detecting that a device is being used to execute an application such as a web browser to access a service such as ChatGPT. This may involve monitoring application usage and/or messages/communications initiated from a particular device, such as a device managed by a business entity. The monitoring may be performed by firewall that monitors incoming and outgoing network traffic. The monitoring may be performed by a component positioned in a network architecture between one or more enterprise user devices and external cloud-based applications.

At block 304, the method 300 involves, in response to detecting the interaction, determining a limitation on the information permitted to be provided to the LLM AI service provider. For example, one or more limitations may be determined based on accessing a usage policy or data privacy policy that specifies allowed and prohibited information that may be provided in a particular context, to particular services, and/or from particular devices. In some implementations, determining the limitation is based on data loss prevention engine (DLP) engine output.

At block 306, the method 300 involves identifying information submitted in a user interface as input to the LLM AI application to prompt a response generated by the LLM AI service provider.

At block 308, the method 200 involves enabling provision of a first subset of less than all of the information to the LLM AI service provider as the input. A second subset, different than the first subset, of the information is withheld from being provided to the LLM AI service provider in accordance with the limitation. Enabling provision of the first subset of less than all of the information may involve filtering the information to remove the second subset of information based on the second subset of information satisfying a criterion. Enabling provision of the first subset of less than all of the information comprising a data loss prevention engine (DLP) identifying sensitive data. Sensitive data may be data that is identified as including personal identifiable information (PII), protected health information (PHI), credit card numbers, enterprise secrets, source code, passwords, passkeys, financial data, merger and acquisition data, and/or data not approved for use outside of an enterprise.

In some implementations, the method 300 additionally or alternatively involves automatically generalizing the first subset of information to remove sensitive information, for example, by removing names, values, substituting general wording for specific wording, etc.

In some implementations, the method 300 additionally involves identifying information received from the LLM AI service provider and associating the received information with the input. Some implementations involve watermarking the information received to associate the information received with a user who provided the input. Some implementations involve logging the first subset of less than all of the information as having been provided to the LLM AI service provider. Some implementations involve initiating a right to be forgotten request to the LLM AI service provider based on determining that the first subset of less than all of the information was provided as input and contains data that satisfies a criterion.

FIG. 4 is a block diagram of a user device 400 of in accordance with some implementations. Device 400 illustrates an exemplary device configuration for electronic device 105 or electronic device 110. The device 400 includes one or more processing units 402 (e.g., microprocessors, ASICs, CPUs, processing cores, and/or the like), one or more input/output (I/O) devices 406, one or more communication interfaces 408 (e.g., USB, IEEE 802.3x, IEEE 802.11x, IEEE 802.16x, GSM, CDMA, TDMA, GPS, IR, BLUETOOTH, ZIGBEE, SPI, I2C, and/or the like type interface), one or more programming (e.g., I/O) interfaces 410, one or more display(s) 412, one or more sensor systems 414, a memory 420, and one or more communication buses 404 for interconnecting these and various other components. The one or more communication buses 404 interconnects and controls communications between system components. The one or more I/O devices 406 may include one or more mice, one or more keyboards, one or more trackpads, on or more touchscreens, one or more microphones, one or more speakers, a haptics engine, etc. The sensor systems 415 may include one or more image sensors, one or more motion sensors, one or more audio sensors, etc.

The memory 420 includes high-speed random-access memory, such as DRAM, SRAM, DDR RAM, or other random-access solid-state memory devices. In some implementations, the memory 420 includes non-volatile memory, such as one or more magnetic disk storage devices, optical disk storage devices, flash memory devices, or other non-volatile solid-state storage devices. The memory 420 optionally includes one or more storage devices remotely located from the one or more processing units 402. The memory 420 comprises a non-transitory computer readable storage medium. In some implementations, the memory 420 or the non-transitory computer readable storage medium of the memory 420 stores an optional operating system 430 and one or more instruction set(s) 440. The operating system 430 includes procedures for handling various basic system services and for performing hardware dependent tasks. In some implementations, the instruction set(s) 440 include executable software defined by binary information stored in the form of electrical charge. In some implementations, the instruction set(s) 440 are software that is executable by the one or more processing units 402 to carry out one or more of the techniques described herein. The instruction set(s) 440 include monitoring instruction set 442 configured to, upon execution, detect interactions with an LLM AI service provider as described herein. The instruction set(s) 440 further include a controlling instruction set 444 configured to, upon execution, control the communication of information to and from an LLM AI source as described herein. The instruction set(s) 440 may be embodied as a single software executable or multiple software executables.

Although the instruction set(s) 440 are shown as residing on a single device, it should be understood that in other implementations, any combination of the elements may be located in separate computing devices. Moreover, FIG. 4 is intended more as functional description of the various features which are present in a particular implementation as opposed to a structural schematic of the implementations described herein. As recognized by those of ordinary skill in the art, items shown separately could be combined and some items could be separated. The actual number of instructions sets and how features are allocated among them may vary from one implementation to another and may depend in part on the particular combination of hardware, software, and/or firmware chosen for a particular implementation.

Numerous specific details are set forth herein to provide a thorough understanding of the claimed subject matter. However, those skilled in the art will understand that the claimed subject matter may be practiced without these specific details. In other instances, methods apparatuses, or systems that would be known by one of ordinary skill have not been described in detail so as not to obscure claimed subject matter.

Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “or” as used herein refers to and encompasses any and all possible combinations of one or more of the associated listed items. It will be further understood that the terms “comprises” or “comprising,” when used in this specification, specify the presence of stated features, integers, steps, operations, elements, or components, but do not preclude the presence or addition of one or more other features, integers, steps, operations, elements, components, or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description and summary of the invention are to be understood as being in every respect illustrative and exemplary, but not restrictive, and the scope of the invention disclosed herein is not to be determined only from the detailed description of illustrative implementations but according to the full breadth permitted by patent laws. It is to be understood that the implementations shown and described herein are only illustrative of the principles of the present invention and that various modification may be implemented by those skilled in the art without departing from the scope and spirit of the invention.

What is claimed is:

1. A method comprising:
at a processor,
monitoring usage of an electronic device to detect an interaction initiated with a large-language model (LLM) artificial intelligence (AI) application associated with an LLM AI service provider;
in response to detecting the interaction, determining a limitation on the information permitted to be provided to the LLM AI service provider;
identifying information submitted in a user interface as input to the LLM AI application to prompt a response generated by the LLM AI service provider; and
enabling provision of a first subset of less than all of the information to the LLM AI service provider as the input, wherein a second subset, different than the first subset, of the information is withheld from being provided to the LLM AI service provider in accordance with the limitation.

2. The method of claim 1, wherein the monitoring is performed by firewall that monitors incoming and outgoing network traffic.

3. The method of claim 1, wherein the monitoring is performed by a component positioned in a network architecture between one or more enterprise user devices and external cloud-based applications.

4. The method of claim 1, wherein enabling provision of the first subset of less than all of the information comprising filtering the information to remove the second subset of information based on the second subset of information satisfying a criterion.

5. The method of claim 1, wherein enabling provision of the first subset of less than all of the information comprising a data loss prevention engine (DLP) identifying sensitive data.

6. The method of claim 5, wherein the sensitive data comprises personal identifiable information (PII), protected health information (PHI), credit card numbers, enterprise secrets, source code, passwords, passkeys, financial data, M&A data, or data not approved for use outside of an enterprise.

7. The method of claim 1 further comprising automatically generalizing the first subset of information to remove sensitive information.

8. The method of claim 1 further comprising identifying information received from the LLM AI service provider and associating the received information with the input.

9. The method of claim 8 further comprising watermarking the information received to associate the information received with a user who provided the input.

10. The method of claim 1 further comprising logging the first subset of less than all of the information as having been provided to the LLM AI service provider.

11. The method of claim 1 further comprising initiating a right to be forgotten request to the LLM AI service provider based on determining that the first subset of less than all of the information was provided as input and contains data that satisfies a criterion.

12. A system comprising:
a non-transitory computer-readable storage medium; and
one or more processors coupled to the non-transitory computer-readable storage medium, wherein the non-transitory computer-readable storage medium comprises program instructions that, when executed on the one or more processors, cause the system to perform operations comprising:
monitoring usage of an electronic device to detect an interaction initiated with a large-language model (LLM) artificial intelligence (AI) application associated with an LLM AI service provider;
in response to detecting the interaction, determining a limitation on the information permitted to be provided to the LLM AI service provider;
identifying information submitted in a user interface as input to the LLM AI application to prompt a response generated by the LLM AI service provider; and
enabling provision of a first subset of less than all of the information to the LLM AI service provider as the input, wherein a second subset, different than the first subset, of the information is withheld from being provided to the LLM AI service provider in accordance with the limitation.

13. The system of claim 12, wherein enabling provision of the first subset of less than all of the information comprising filtering the information to remove the second subset of information based on the second subset of information satisfying a criterion.

14. The system of claim 12, wherein enabling provision of the first subset of less than all of the information comprising a data loss prevention engine (DLP) identifying sensitive data.

15. The system of claim 14, wherein the sensitive data comprises personal identifiable information (PII), protected health information (PHI), credit card numbers, enterprise secrets, source code, passwords, passkeys, financial data, M&A data, or data not approved for use outside of an enterprise.

16. The system of claim 14 further comprising automatically generalizing the first subset of information to remove sensitive information.

17. A non-transitory computer-readable storage medium, storing instructions executable via one or more processors to perform operations comprising:
monitoring usage of an electronic device to detect an interaction initiated with a large-language model (LLM) artificial intelligence (AI) application associated with an LLM AI service provider;
in response to detecting the interaction, determining a limitation on the information permitted to be provided to the LLM AI service provider;
identifying information submitted in a user interface as input to the LLM AI application to prompt a response generated by the LLM AI service provider; and
enabling provision of a first subset of less than all of the information to the LLM AI service provider as the input, wherein a second subset, different than the first subset, of the information is withheld from being provided to the LLM AI service provider in accordance with the limitation.
